(19) United States
(12) Patent Application Publication
(10) Pub. No.: US 2022/0272636 A1
(43) Pub. Date: Aug. 25, 2022

(54) POWER-SAVING SIGNAL MONITORING METHOD AND TERMINAL

(71) Applicant: VIVO MOBILE COMMUNICATION CO., LTD., Dongguan (CN)

(72) Inventors: Dongru LI, Dongguan (CN); Dajie JIANG, Dongguan (CN); Xiaodong SHEN, Dongguan (CN); Kai WU, Dongguan (CN); Xueming PAN, Dongguan (CN)

(73) Assignee: VIVO MOBILE COMMUNICATION CO., LTD., Dongguan (CN)

(21) Appl. No.: 17/723,431

(22) Filed: Apr. 18, 2022

Related U.S. Application Data
(63) Continuation of application No. PCT/CN2020/123876, filed on Oct. 27, 2020.

(30) Foreign Application Priority Data
Oct. 31, 2019 (CN) 201911055323.X
Jan. 15, 2020 (CN) 202010043462.7

(51) Int. Cl. H04W 52/02

(52) U.S. Cl. CPC H04W 52/0232; H04W 52/0235; H04W 52/0274

(57) ABSTRACT

A power-saving signal monitoring method and a terminal are provided. The power-saving signal monitoring method includes: monitoring a power-saving signal based on at least one target power-saving signal Monitoring Occasion (MOs) of power-saving signal MOs associated with onduration of CDRX. The power-saving signal MOs are determined based on a power-saving signal offset and a search space parameter. The power-saving signal offset is an offset relative to the onduration of the CDRX. The search space parameter includes at least one of the following: a monitoring period, a monitoring offset, or a monitoring duration.

### CROSS-REFERENCE TO RELATED APPLICATIONS

This application is a continuation of International Application No. PCT/CN2020/123876, filed Oct. 27, 2020, which claims priority to Chinese Patent Application No. 201911055323.X, filed on Oct. 31, 2019; and Chinese Patent Application No. 202010043462.7, filed on Jan. 15, 2020. The entire contents of each of the above-identified applications are expressly incorporated herein by reference.

### TECHNICAL FIELD

The present disclosure relates to the field of communications technologies, and in particular, to a power-saving signal monitoring method and a terminal.

### BACKGROUND

To further improve the power-saving effect of a terminal in a communication system (for example, a 5G system), a power-saving signal, such as a Wake Up Signal (WUS), is supported. The power-saving signal can indicate the terminal to wake up or sleep. If the power-saving signal indicates the terminal to wake up, the terminal monitors a Physical Downlink Control CHannel (PDCCH) in onduration of Connected Discontinuous Reception CDRX) associated with the power-saving signal. If the power-saving signal indicates the terminal to sleep, the terminal does not monitor the PDCCH in the onduration of the CDRX associated with the power-saving signal. However, a solution to how the terminal monitors the power-saving signal is not yet determined, resulting in a poor power-saving effect of the terminal.

### SUMMARY

Embodiments of the present disclosure provide a power-saving signal monitoring method and a terminal, to resolve a problem of a poor power-saving effect of a terminal.

According to a first aspect, an embodiment of the present disclosure provides a power-saving signal monitoring method, including:

monitoring a power-saving signal based on at least one target power-saving signal MO of power-saving signal Monitoring Occasions (MOs) associated with onduration of connected discontinuous reception CDRX; where the power-saving signal MO is determined based on a power-saving signal offset and a search space parameter, the power-saving signal offset is an offset relative to the onduration of the CDRX, and the search space parameter includes at least one of the following: a monitoring period, a monitoring offset, and a monitoring duration.

According to a second aspect, an embodiment of the present disclosure provides a terminal, including:

a monitoring module, configured to monitor a power-saving signal based on at least one target power-saving signal MO of power-saving signal monitoring occasions MO associated with onduration of CDRX; where the power-saving signal MO is determined based on a power-saving signal offset and a search space parameter, the power-saving signal offset is an offset relative to the onduration of the CDRX, and the search space parameter includes at least one of the following: a monitoring period, a monitoring offset, and a monitoring duration.

According to a third aspect, an embodiment of the present disclosure provides a terminal, including a memory, a processor, and a program stored in the memory and executable on the processor, where when the program is executed by the processor, the steps of the power-saving signal monitoring method provided in the embodiments of the present disclosure are implemented.

According to a fourth aspect, an embodiment of the present disclosure provides a computer-readable storage medium, where the computer-readable storage medium stores a computer program, and when the computer program is executed by a processor, the steps of the power-saving signal monitoring method provided in the embodiments of the present disclosure are implemented.

In the embodiments of the present disclosure, a power-saving signal is monitored based on at least one target power-saving signal MO of power-saving signal monitoring occasions MO associated with onduration of CDRX; where the power-saving signal MO is determined based on a power-saving signal offset and a search space parameter, the power-saving signal offset is an offset relative to the onduration of the CDRX, and the search space parameter includes at least one of the following: a monitoring period, a monitoring offset, and a monitoring duration. In this way, the power-saving signal can be monitored based on the at least one target power-saving signal MO, thereby improving the monitoring capability of the terminal.

### BRIEF DESCRIPTION OF DRAWINGS

FIG. 1 is a structural diagram of a network system applicable to an embodiment of the present disclosure;

FIG. 2 is a flowchart of a power-saving signal monitoring method according to an embodiment of the present disclosure;

FIG. 3 is a schematic diagram of a power-saving signal MO according to an embodiment of the present disclosure;

FIG. 4 is a schematic diagram of power-saving signal detection according to an embodiment of the present disclosure;

FIG. 5 is a structural diagram of another terminal according to an embodiment of the present disclosure;

FIG. 6 is a structural diagram of another terminal according to an embodiment of the present disclosure;

FIG. 7 is a structural diagram of another terminal according to an embodiment of the present disclosure;

FIG. 8 is a structural diagram of another terminal according to an embodiment of the present disclosure;

FIG. 9 is a structural diagram of another terminal according to an embodiment of the present disclosure;

FIG. 10 is a structural diagram of another terminal according to an embodiment of the present disclosure; and

FIG. 11 is a structural diagram of another terminal according to an embodiment of the present disclosure.

### DETAILED DESCRIPTION OF EMBODIMENTS

The following clearly and completely describes the technical solutions in the embodiments of this disclosure with reference to the accompanying drawings in the embodiments of this disclosure. Apparently, the described embodiments are some rather than all of the embodiments of this disclosure. All other embodiments acquired by a person of ordinary skill in the art based on the embodiments of the present disclosure without creative efforts shall fall within the protection scope of the present disclosure.

The term “include” and any other variants in the description and the claims of this application are intended to cover a non-exclusive inclusion, for example, a process, method, system, product, or device that includes a list of steps or units is not necessarily limited to those expressly listed steps or units, but may include other steps or units not expressly listed or inherent to such a process, method, product, or device. In addition, “and/or” used in the specification and the claims means at least one of the connected objects. For example, A and/or B represents the following three cases: Only A exists, only B exists, and both A and B exist.

In the embodiments of the present disclosure, the word such as “example” or “for example” is used to represent giving an example, an illustration, or a description. Any embodiment or design scheme described as “exemplary” or “for example” in the embodiments of the present disclosure should not be construed as being more preferred or advantageous than other embodiments or design schemes. To be precise, the use of the term such as “exemplary” or “for example” is intended to present a related concept in a specific manner.

The embodiments of the present disclosure are described below with reference to the accompanying drawings. A power-saving signal monitoring method and a terminal provided in the embodiments of the present disclosure may be applied to a wireless communications system. The wireless communications system may be a New Radio (NR) system, or other systems such as an evolved Long Term Evolution (eLTE) system, or a Long Term Evolution (LTE) system, or a subsequent evolved communication system.

Referring to FIG. 1, FIG. 1 is a structural diagram of a network system applicable to an embodiment of the present disclosure. As shown in FIG. 1, the network system includes a terminal 11 and a network device 12. The terminal 11 may be User Equipment (UE) or other terminal side devices, for example: a mobile phone, a tablet personal computer, a laptop computer, a Personal Digital Assistant (PDA), a Mobile Internet Device (MID), a wearable device or a robot. It should be noted that a specific type of the terminal 11 is not limited in the embodiments of the present disclosure. The network device 12 may be a base station in 4G or a base station in 5G or later releases, or a base station in other communications systems, or is referred to as a Node B, an evolved Node B, a Transmission Reception Point (TRP), an Access Point (AP), or other words in the field, as long as the same technical effect is achieved. The network device is not limited to specific technical words. In addition, the network device 12 may be a Master Node (MN) or a Secondary Node (SN). It should be noted that in embodiments of the present disclosure, only the base station in 5G is used as an example, but a specific type of the network device is not limited.

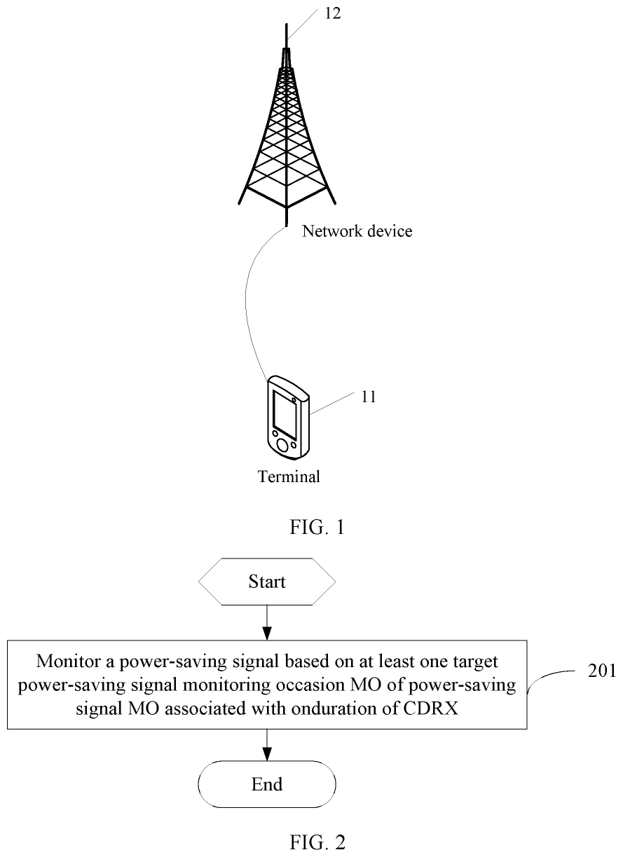

Referring to FIG. 2, FIG. 2 is a flowchart of a power-saving signal monitoring method according to an embodiment of the present disclosure. As shown in FIG. 2, the method includes the following step:

Step 201: Monitor a power-saving signal based on at least one target power-saving signal MO of power-saving signal monitoring occasions MO associated with onduration of CDRX; where the power-saving signal MO is determined based on a Power-saving Signal offset (PS-offset) and a search space parameter, the power-saving signal offset is an offset relative to the onduration of the CDRX, and the search space parameter includes at least one of the following: a monitoring period, a monitoring offset, and a monitoring duration.

In the embodiments of the present disclosure, the power-saving signal may include a WUS, a Go To Sleep (GTS) signal, and the like. Further, a WUS may also be referred to as a PDCCH scrambled by using a Power-saving Signal-Radio Network Temporary Identifier (PS-RNTI), or a Power-saving Signal-PDCCH (PS-PDCCH), or a Downlink Control Information format 30 (DCI format 30), or the like. In addition, the onduration of the CDRX may be referred to as DRX ON.

The power-saving signal offset and the search space parameter may be configured by the network side for the terminal, for example, configured for the terminal through RRC signaling. Certainly, this is not limited. For example, the power-saving signal offset and the search space parameter may also be specified in a protocol. The unit of the power-saving signal offset is ms, and certainly can be other forms such as subframe, slot, or symbol.

If the power-saving signal MO that is determined according to the PS-offset and the search space parameter and that indicates an action of the terminal in DRX ON exists, the action of the terminal is determined based on the power-saving signal MO. A monitoring range may be determined based on at least one parameter of the power-saving signal offset, and a monitoring period, a monitoring offset, or a monitoring duration belonging to the search space. The range may be a range in time domain, and is smaller than the PS-offset. If the power-saving signal MO that is determined according to the PS-offset and the search space parameter and that indicates an action of the terminal in DRX ON does not exist, the terminal monitors a physical downlink control channel PDCCH in the onduration of the CDRX. It should be noted that, in this embodiment of the present disclosure, the search space may also be referred to as a PS Search space.

Determining the power-saving signal MO according to the PS-offset and the search space parameter may be: determining that a power-saving signal MO that satisfies the power-saving signal offset and belongs to the search space is the power-saving signal MO associated with the onduration of the CDRX, for example, determining a power-saving signal MO that is between the power-saving signal offset and the onduration of the CDRX and belongs to the search space.

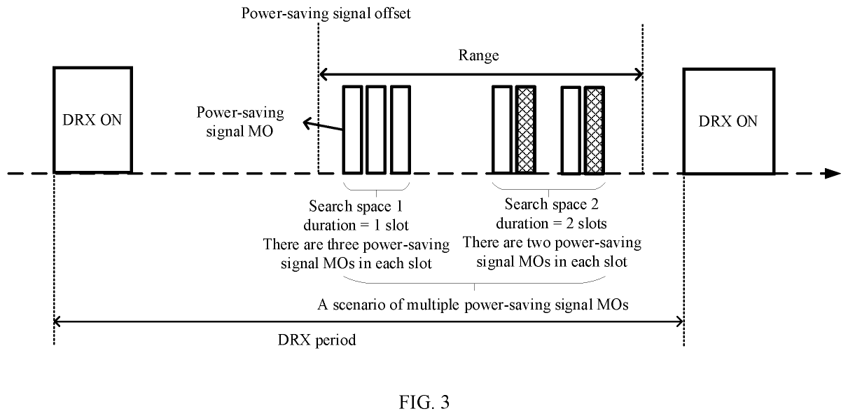

For example, in FIG. 3, two search spaces are determined based on the PS-offset and the search space parameter. The monitoring duration of search space 1 is 1 slot, and there are 3 power-saving signal MOs in each slot. The monitoring duration of search space 2 is 2 slots, and there are 2 power-saving signal MOs in each slot. In this way, 7 power-saving signal MOs satisfying the monitoring range can be determined. That is, 7 power-saving signal MOs that are associated with the onduration of the CDRX and that are determined according to the PS-offset and the search space parameter are determined.

The monitoring a power-saving signal based on the at least one target power-saving signal MO may be: monitoring a power-saving signal in each of the at least one target power-saving signal MO, or monitoring a power-saving signal in a part of the at least one target power-saving signal MO.

Further, after detecting a power-saving signal, the terminal may perform a corresponding monitoring action based on the indication of the power-saving signal, such as: wake up or sleep. The corresponding monitoring action specifically may be monitoring a PDCCH in the onduration of the CDRX, or skipping monitoring a PDCCH in the onduration of the CDRX.

In this embodiment of the present disclosure, in the above step, the power-saving signal can be monitored based on the at least one target power-saving signal MO, thereby improving the power-saving effect of the terminal.

As an optional implementation, the step of monitoring a power-saving signal based on at least one target power-saving signal MO of power-saving signal MOs associated with onduration of CDRX includes:

selecting Z power-saving signal MOs that do not overlap with a first resource from the power-saving signal MOs associated with the onduration of the CDRX; where Z is an integer greater than or equal to 0; and

monitoring a power-saving signal based on at least one target power-saving signal MO of the Z power-saving signal MOs.

That the Z power-saving signal MOs do not overlap with the first resource may be: none of the Z power-saving signal MOs overlaps with the first resource. That a power-saving signal MO does not overlap with the first resource may be: the first resource does not overlap with all or a part of resources of the power-saving signal MO.

The first resource may be used to transmit important signals or channels. If a power-saving signal MO overlaps with the first resource, it means that the terminal needs to send or receive important signals or channels in the power-saving signal MO. The important signals or channels may be defined in the protocol or configured for the terminal by the network side.

In some embodiments, the first resource includes at least one of the following:

a resource for transmitting a first signal or a first channel;

a flexible symbol;

an uplink symbol;

a Synchronization Signal Block-based measurement timing configuration (SSB-based Measurement Timing Configuration (SMTC)) resource; and

a PDCCH candidate resource, where at least one Resource Element (RE) of the PDCCH candidate resource is a rate matching resource of Radio Resource Control (RRC) configuration.

The PDCCH candidate resource may be a PDCCH candidate resource in a COntrol REsource SET (CORESET) of a power-saving signal.

The first signal or the first channel may include at least one of the following:

a SSB, a Channel State Indication-Reference Signal (CSI-RS), a Physical Uplink Control CHannel (PUCCH), a Physical Uplink Shared CHannel (PUSCH), a Sounding Reference Signal (SRS), and a Random Access Response (RAR).

For example, the first resource may include a resource on which the network side uses DCI to indicate that some or all symbols are used for PUCCH, PUSCH, PRACH or SRS transmission, or the first resource may include a resource on which the network side uses DCI to indicate that some or all symbols are flexible symbols or uplink symbols, or the first resource may include resources used for SSB or CSI-RS measurement, or the first resource may include a PDCCH monitoring moment for scheduling a RAR at a monitoring moment corresponding to a receiving RAR search space after the terminal initiates random access.

In this implementation, a power-saving signal may be monitored based on at least one target power-saving signal MO of the Z power-saving signal MOs, to reduce the power consumption of the terminal and avoid missing the signal or the channel transmitted on the first resource, to improve the overall performance of the terminal.

In some embodiments, the method further includes the following monitoring actions:

monitoring action 1: monitoring a PDCCH in the onduration of the CDRX in a case that Z is equal to 0.

That Z is equal to 0 may be: no power-saving signal MO that does not overlap with the first resource is determined in the power-saving signal MO associated with the onduration of the CDRX. In this case, the PDCCH in the onduration of the CDRX is monitored, to improve the monitoring performance of the terminal.

In some embodiments, the step of monitoring a power-saving signal based on at least one target power-saving signal MO of the Z power-saving signal MOs includes:

monitoring action 2: in a case that Z is greater than or equal to 1, monitoring a power-saving signal based on at least one target power-saving signal MO of the Z power-saving signal MOs.

That Z is greater than or equal to 1 may be: one or more power-saving signal MOs that do not overlap with the first resource are determined in the power-saving signal MO associated with the onduration of the CDRX. In this case, a power-saving signal is monitored based on at least one target power-saving signal MO of the Z power-saving signal MOs, to improve the power-saving effect of the terminal.

It should be noted that, in the case that Z is greater than or equal to 1, the at least one target power-saving signal MO may be all or some of the Z power-saving signal MOs. Further, the target power-saving signal MO may be referred to as a valid power-saving signal MO.

In some embodiments, the step of monitoring a power-saving signal based on at least one target power-saving signal MO of the Z power-saving signal MOs includes:

monitoring action 2-1: monitoring a power-saving signal in the Z power-saving signal MOs in a case that Z is equal to 1;

or

monitoring action 2-2: selecting M target power-saving signal MOs from the Z power-saving signal MOs in a case that Z is greater than 1, and monitoring a power-saving signal based on the M target power-saving signal MOs; where the M target power-saving signal MOs are M power-saving signal MOs closest to the onduration of the CDRX or M power-saving signal MOs farthest from the onduration of the CDRX among the Z power-saving signal MOs; and M is an integer greater than 1 and less than Z.

The M power-saving signal MOs closest to the onduration of the CDRX may be the first M power-saving signal MOs in ascending order of intervals from the onduration of the CDRX. The M power-saving signal MOs farthest from the onduration of the CDRX may be the first M power-saving signal MOs in descending order of intervals from the onduration of the CDRX.

In this implementation, the power-saving signal can be monitored based on the M target power-saving signal MOs, thereby improving the power-saving effect of the terminal.

In an optional implementation, the step of monitoring a power-saving signal based on at least one target power-saving signal MO includes:

monitoring a power-saving signal from the first power-saving signal MO of the at least one target power-saving signal MO; and

monitoring action 3: in a case that a first power-saving signal indicating to monitor a PDCCH in the onduration of the CDRX is detected, skipping monitoring a subsequent target power-saving signal MO; or

monitoring action 4: in a case that the power-saving signal is not detected or a second power-saving signal indicating not to monitor the PDCCH in the onduration of the CDRX is detected, continuing to monitor a next target power-saving signal MO until the first power-saving signal is detected or monitoring of the last target power-saving signal MO of the at least one target power-saving signal MO is completed.

The first power-saving signal is a power-saving signal that indicates the terminal to monitor the PDCCH in the onduration of the CDRX, that is, indicates the terminal to “wake up”.

The second power-saving signal is a power-saving signal that indicates the terminal not to monitor the PDCCH in the onduration of the CDRX, that is, indicates the terminal to “sleep”.

It should be noted that, for a CDRX onduration, a terminal does not expect to receive more than one power-saving signals with inconsistent indicating contents, on multiple power-saving signal MOs. For example, for a CDRX onduration, the terminal does not expect to receive, on multiple power-saving signal MOs, a power-saving signal indicating the terminal to monitor the PDCCH and another power-saving signal indicating the terminal not to monitor the PDCCH, respectively. That is, for a CDRX onduration, the terminal receives, on multiple power-saving signal MOs, more than one power-saving signals with inconsistent indicating contents is an error case.

It should be noted that, the step of monitoring a power-saving signal based on at least one target power-saving signal MO may be any step of monitoring a power-saving signal based on at least one target power-saving signal MO provided in the embodiments of the present disclosure, for example: step 201, or the step of monitoring a power-saving signal based on at least one target power-saving signal MO of the Z power-saving signal MOs, or the step of monitoring a power-saving signal based on the M target power-saving signal MOs.

In this implementation, if the first power-saving signal is detected, no power-saving signal is monitored. If the second power-saving signal is detected or no power-saving signal is detected, the monitoring continues, until monitoring of the at least one target power-saving signal MO is completed or the first power-saving signal is detected, thereby reducing power consumption of the terminal.

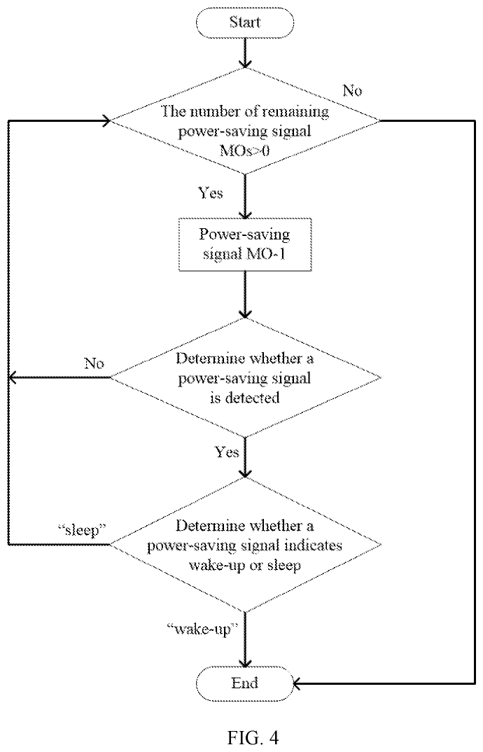

For example: as shown in FIG. 4, when the number of remaining power-saving signal MOs of the at least one target power-saving signal MO is greater than 0, it is determined whether a power-saving signal is detected. If yes, it is determined whether the power-saving signal indicates wake up or sleep. If the power-saving signal indicates wake up, the monitoring process ends, or if all detected power-saving signals indicate sleep, the monitoring process ends, or no power-saving signal is detected in all the power-saving signal MOs, the monitoring process ends.

In some embodiments, the method further includes:

monitoring action 5: in a case that the first power-saving signal is detected, monitoring the PDCCH in the onduration of the CDRX; or

monitoring action 6: in a case that power-saving signals detected in the at least one target power-saving signal MO are all the second power-saving signal, skipping monitoring the PDCCH in the onduration of the CDRX; or

monitoring action 7: in a case that no power-saving signal is detected in the at least one target power-saving signal MO, performing a preset behavior.

The preset behavior may be configured through RRC or a default action, for example, monitoring a PDCCH in the onduration of the CDRX or skipping monitoring a PDCCH in the onduration of the CDRX.

In this implementation, the power consumption of the terminal can be reduced based on the detected power-saving signal.

As an optional implementation, the step of monitoring a power-saving signal based on at least one target power-saving signal MO includes:

monitoring action 8: monitoring a power-saving signal in the first power-saving signal MO or the last power-saving signal MO of the at least one target power-saving signal MO.

It should be noted that, the step of monitoring a power-saving signal based on at least one target power-saving signal MO may be any step of monitoring a power-saving signal based on at least one target power-saving signal MO provided in the embodiments of the present disclosure, for example: step 201, or the step of monitoring a power-saving signal based on at least one target power-saving signal MO of the Z power-saving signal MOs, or the step of monitoring a power-saving signal based on the M target power-saving signal MOs.

In this implementation, because a power-saving signal is monitored in the first power-saving signal MO or the last power-saving signal MO of the at least one target power-saving signal MO, the power-saving effect of the terminal is further improved.

In some embodiments, the method further includes:

monitoring action 9: in a case that a power-saving signal is detected, performing a monitoring action according to the detected power-saving signal, where the monitoring action includes monitoring the PDCCH in the onduration of the CDRX, or skipping monitoring the PDCCH in the onduration of the CDRX; or

monitoring action 10: in a case that no power-saving signal is detected, performing a preset behavior.

When the monitoring action includes monitoring the PDCCH in the onduration of the CDRX, the detected power-saving signal may indicate wake up, that is, indicate to monitor the PDCCH in the onduration of the CDRX. When the monitoring action includes skipping monitoring the PDCCH in the onduration of the CDRX, the detected power-saving signal may indicate sleep, that is, indicate to skip monitoring the PDCCH in the onduration of the CDRX.

The preset behavior may be configured through RRC or a default action, for example, monitoring a PDCCH in the onduration of the CDRX or skipping monitoring a PDCCH in the onduration of the CDRX.

As an optional implementation, the step of monitoring a power-saving signal based on at least one target power-saving signal MO includes:

monitoring a power-saving signal in the at least one target power-saving signal MO.

It should be noted that, the step of monitoring a power-saving signal based on at least one target power-saving signal MO may be any step of monitoring a power-saving signal based on at least one target power-saving signal MO provided in the embodiments of the present disclosure, for example: step 201, or the step of monitoring a power-saving signal based on at least one target power-saving signal MO of the Z power-saving signal MOs, or the step of monitoring a power-saving signal based on the M target power-saving signal MOs.

In this implementation, a power-saving signal can be monitored in the at least one target power-saving signal MO, thereby improving the probability of detecting a power-saving signal.

In some embodiments, the method further includes:

monitoring action 11: in a case of detecting that the number of first power-saving signals indicating to monitor the PDCCH in the onduration of the CDRX is greater than or equal to N, monitoring the PDCCH in the onduration of the CDRX, where N is an integer greater than or equal to 1; or

monitoring action 12: in a case of detecting that the number of second power-saving signals indicating not to monitor the PDCCH in the onduration of the CDRX is greater than or equal to X, skipping monitoring the PDCCH in the onduration of the CDRX, where X is an integer greater than or equal to 1; or

monitoring action 13: in a case that power-saving signals detected in the at least one target power-saving signal MO are all the second power-saving signal, skipping monitoring the PDCCH in the onduration of the CDRX; or

monitoring action 14: in a case that no power-saving signal is detected in the at least one target power-saving signal MO, performing a preset behavior.

N and X are notified to the terminal through RRC signaling, or defined in the protocol, or determined according to a rule defined in the protocol. For example, X=the number of target power-saving signal MOs multiplied by a ratio. The ratio is configured through RRC or defined in the protocol.

In this implementation, as long as the number of first power-saving signals indicating the terminal to monitor the PDCCH in the onduration of the CDRX is greater than or equal to N, the terminal monitors the PDCCH in the onduration of the CDRX. Even if a power-saving signal indicating not to monitor the PDCCH in the onduration of the CDRX is detected, the terminal also monitors the PDCCH in the onduration of the CDRX.

In a case of detecting that the number of second power-saving signals indicating not to monitor the PDCCH in the onduration of the CDRX is greater than or equal to X, the terminal skips monitoring the PDCCH in the onduration of the CDRX.

Besides, in a case of detecting that all power-saving signals indicate not to monitor the PDCCH in the onduration of the CDRX, the terminal skips monitoring the PDCCH in the onduration of the CDRX.

For the preset behavior, refer to the description of the foregoing implementation. Details are not described herein again.

In some embodiments, the method further includes:

in the same onduration of the CDRX, the terminal does not expect to receive a power-saving signal indicating the terminal to monitor the PDCCH in a subsequent power-saving signal MO, after a power-saving signal indicating the terminal not to monitor the PDCCH in one or more power-saving signal MOs is received;

or

in the same onduration of the CDRX, if the terminal receives a power-saving signal indicating the terminal not to monitor the PDCCH in a subsequent power-saving signal MO, after a power-saving signal indicating the terminal to monitor the PDCCH in one or more power-saving signal MOs is received the terminal skips monitoring the PDCCH.

As an optional embodiment, the step of monitoring a power-saving signal based on at least one target power-saving signal MO includes:

monitoring action 15: in a case that a third power-saving signal indicating not to start an onduration timer (drx-ondurationtimer) of a next DRX period is detected in the at least one target power-saving signal MO, skipping monitoring a subsequent target power-saving signal MO. That is, within the monitoring range of the at least one target power-saving signal MO, if it is detected that a power-saving signal (for example a WUS, a wake-up indication field in DCI of a PS-PDCCH) indicates “not wake-up”, UE stops monitoring.

Further, the method further includes: in a case that the third power-saving signal is detected, skipping starting the onduration timer (drx-ondurationtimer) in the next DRX period. That is, in a case of detecting the third power-saving signal in the at least one target power-saving signal MO, the terminal skips starting the onduration timer (drx-ondurationtimer) in the next DRX period while skipping monitoring a subsequent target power-saving signal MO.

Alternatively, the step of monitoring a power-saving signal based on at least one target power-saving signal MO includes:

monitoring action 16: in a case that a fourth power-saving signal indicating to start an onduration timer (drx-ondurationtimer) of a next DRX period is detected in the at least one target power-saving signal MO, continuing to monitor a next target power-saving signal MO. That is, within the monitoring range of the at least one target power-saving signal MO, if it is detected that a power-saving signal (for example, a WUS) indicates “wake-up”, UE does not stop monitoring and continues to monitor an MO.

In some embodiments, the monitoring action 16 may include: in a case that the fourth power-saving signal is detected, continuing to monitor a next target power-saving signal MO until the third power-saving signal is detected or monitoring of the last target power-saving signal MO of the at least one target power-saving signal MO is completed.

Further, in the monitoring action 16, in a case that power-saving signals detected in the at least one target power-saving signal MO are all the fourth power-saving signal, the terminal starts the onduration timer (drx-ondurationtimer) in the next DRX period.

In some optional embodiments, the step of monitoring a power-saving signal based on at least one target power-saving signal MO includes:

monitoring action 17: in a case that the third power-saving signal and the fourth power-saving signal in the at least one target power-saving signal MO are detected, performing a preset behavior, or stopping monitoring a subsequent target power-saving signal MO and performing a preset behavior; where

the third power-saving signal indicates not to start an onduration timer (drx-ondurationtimer) of a next DRX period, and the fourth power-saving signal indicates to start an onduration timer (drx-ondurationtimer) of a next DRX period.

That is, in some embodiments, the terminal or the network device does not expect inconsistent indications to appear in multiple target power-saving signal MOs, and when inconsistent indications appear, the terminal determines this as an error case and performs a preset behavior; or stops monitoring a subsequent target power-saving signal MO and performs a preset behavior. For example, if inconsistent indications are detected in all target power-saving signal MOs, the terminal determines this as an error case, stops monitoring, and performs a preset behavior.

In some embodiments, after monitoring of the at least one target power-saving signal MO is completed, in a case of detecting the third power-saving signal and the fourth power-saving signal in these target power-saving signal MOs, the terminal performs a preset behavior. Alternatively, in a case of detecting the third power-saving signal and the fourth power-saving signal in a process of monitoring the at least one target power-saving signal MO, the terminal determines that an error case occurs, stops monitoring a subsequent target power-saving signal MO, and performs a preset behavior.

In some embodiments, the step of monitoring a power-saving signal based on at least one target power-saving signal MO includes:

monitoring action 18: in a case that incorrect monitoring occurs in the at least one target power-saving signal MO, performing a preset behavior. For example, within the monitoring range of the at least one target power-saving signal MO, if the UE performs incorrect monitoring, the UE performs a preset behavior;

or

monitoring action 19: in a case that incorrect monitoring occurs in the at least one target power-saving signal MO, skipping monitoring a subsequent target power-saving signal MO and performing a preset behavior. For example, within the monitoring range of the at least one target power-saving signal MO, in a case that incorrect monitoring occurs in at least one target power-saving signal MO, the terminal skips monitoring a remaining target power-saving signal MO and performs a preset behavior.

In the embodiments of the present disclosure, the at least one target power-saving signal MO is: all power-saving signal MOs associated with the onduration of the CDRX, or the at least one target power-saving signal MO is: a power-saving signal MO other than an invalid power-saving signal MO among power-saving signal MOs associated with the onduration of the CDRX. The invalid power-saving signal MO is a power-saving signal MO that overlaps with the first resource, and/or a power-saving signal MO in which the terminal does not need to perform monitoring. The number of invalid power-saving signal MOs may be 0 or greater than or equal to 1, that is, all or some of power-saving signal MOs associated with the onduration of the CDRX are valid.

In another embodiment of the present disclosure, the method further includes:

monitoring action 20: in a case that power-saving signal MOs associated with the onduration of the CDRX include an invalid power-saving signal MO, skipping monitoring other power-saving signal MOs, and performing a preset behavior. For example, within the monitoring range of the at least one target power-saving signal MO, as long as a target power-saving signal MO is invalid, the terminal skips monitoring other power-saving signal MOs, and performs a preset behavior.

In an embodiment of the present disclosure, before the step of monitoring a power-saving signal based on at least one target power-saving signal MO, the method further includes:

receiving RRC signaling, where the RRC signaling carries first information for indicating the at least one target power-saving signal MO, and/or second information for indicating a monitoring action on the at least one target power-saving signal MO. The RRC signaling that carries the first information and the RRC signaling that carries the second information may be the same signaling, or may be different signaling.

When the RRC signaling carries the second information, the terminal monitors a power-saving signal in the at least one target power-saving signal MO based on the RRC signaling. That is, within the monitoring range of the at least one target power-saving signal MO, the monitoring action of the UE is determined according to RRC configuration, and the monitoring action mentioned herein may include, but is not limited to the actions listed in the embodiments of the present disclosure.

For example, if it is detected that a power saving signal (for example, a WUS) indicates “wake-up”, the UE does not stop monitoring and continues to monitor the target power saving signal MO, or the UE stops monitoring according to the UE action of the RRC configuration.

If it is detected that a power saving signal (for example, a WUS) indicates “not wake-up”, the UE does not stop monitoring and continues to monitor the target power saving signal MO, or the UE stops monitoring according to the UE action of the RRC configuration.

If it is detected that a power saving signal (for example, a WUS) is incorrectly monitored by the UE, the UE does not stop monitoring according to the UE action of the RRC configuration, and continues to monitor the target power saving signal MO or the UE stops monitoring.

In this embodiment of the present disclosure, the incorrect monitoring of the target power-saving signal MO may refer to a case in which the Cyclic Redundancy Check (CRC) of DCI corresponding to a PS-PDCCH fails, or other check fails, or the like. This is not limited.

The preset behaviors mentioned in monitoring actions 15 to 20 in the embodiments of the present disclosure include default actions configured or not configured through RRC, for example, starting the drx-ondurationtimer of the next DRX period (or referred to as monitoring the PDCCH in the onduration of the CDRX); or skipping starting the drx-ondurationtimer of the next DRX period (or referred to as skipping monitoring the PDCCH in the onduration of the CDRX).

It is worth pointing out that the monitoring range mentioned in monitoring actions 15 to 20 in the embodiments of the present disclosure is specified in the protocol. The monitoring range may be a range from the PS-offset to the next DRX ON from which the minimum gap is removed. If an SS crosses the PS-offset, the entire SS is invalid. If the target power-saving signal MO satisfies the monitoring range, it indicates that the target power-saving signal MO is valid.

In the embodiments of the present disclosure, a power-saving signal is monitored based on at least one target power-saving signal MO of power-saving signal MOs associated with onduration of CDRX; where the power-saving signal MO is determined based on a power-saving signal offset and a search space parameter, the power-saving signal offset is an offset relative to the onduration of the CDRX, and the search space parameter includes at least one of the following: a monitoring period, a monitoring offset, and a monitoring duration. In this way, the power-saving signal can be monitored based on the at least one target power-saving signal MO, thereby improving the monitoring capability of the terminal.

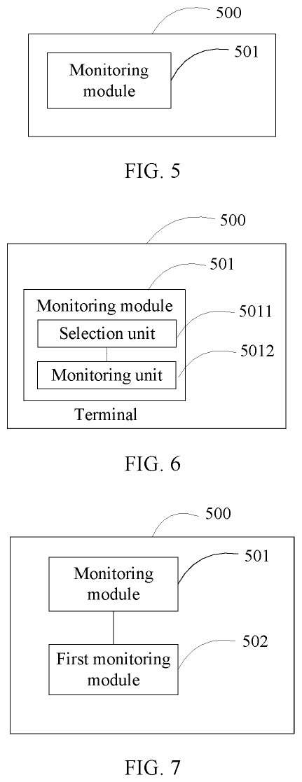

Referring to FIG. 5, FIG. 5 is a structural diagram of a terminal according to an embodiment of the present disclosure. As shown in FIG. 5, the terminal 500 includes:

a monitoring module 501, configured to monitor a power-saving signal based on at least one target power-saving signal MO of power-saving signal MOs associated with onduration of CDRX; where the power-saving signal MO is determined based on a power-saving signal offset and a search space parameter, the power-saving signal offset is an offset relative to the onduration of the CDRX, and the search space parameter includes at least one of the following: a monitoring period, a monitoring offset, and a monitoring duration.

In some embodiments, as shown in FIG. 6, the monitoring module 501 includes:

a selection unit 5011, configured to select Z power-saving signal MOs that do not overlap with a first resource from the power-saving signal MOs associated with the onduration of the CDRX; where Z is an integer greater than or equal to 0; and

a monitoring unit 5012, configured to monitor a power-saving signal based on at least one target power-saving signal MO of the Z power-saving signal MOs.

In some embodiments, as shown in FIG. 7, the terminal 500 further includes:

a first monitoring module 502, configured to monitor a physical downlink control channel PDCCH in the onduration of the CDRX in a case that Z is equal to 0.

In some embodiments, the monitoring unit 5012 is configured to: in a case that Z is greater than or equal to 1, monitor a power-saving signal based on at least one target power-saving signal MO of the Z power-saving signal MOs.

In some embodiments, the monitoring unit 5012 is configured to: in a case that Z is greater than or equal to 1, monitor a power-saving signal in the Z power-saving signal MOs in a case that Z is equal to 1;

or

the monitoring unit 5012 is configured to: select M target power-saving signal MOs from the Z power-saving signal MOs in a case that Z is greater than 1, and monitor a power-saving signal based on the M target power-saving signal MOs; where the M target power-saving signal MOs are M power-saving signal MOs closest to the onduration of the CDRX or M power-saving signal MOs farthest from the onduration of the CDRX among the Z power-saving signal MOs; and M is an integer greater than 1 and less than Z.

In some embodiments, the monitoring module 501 is configured to monitor a power-saving signal from the first power-saving signal MO of the at least one target power-saving signal MO; and

in a case that a first power-saving signal indicating to monitor a physical downlink control channel PDCCH in the onduration of the CDRX is detected, skip monitoring a subsequent target power-saving signal MO; or

in a case that the power-saving signal is not detected or a second power-saving signal indicating not to monitor the PDCCH in the onduration of the CDRX is detected, continue to monitor a next target power-saving signal MO until the first power-saving signal is detected or monitoring of the last target power-saving signal MO of the at least one target power-saving signal MO is completed.

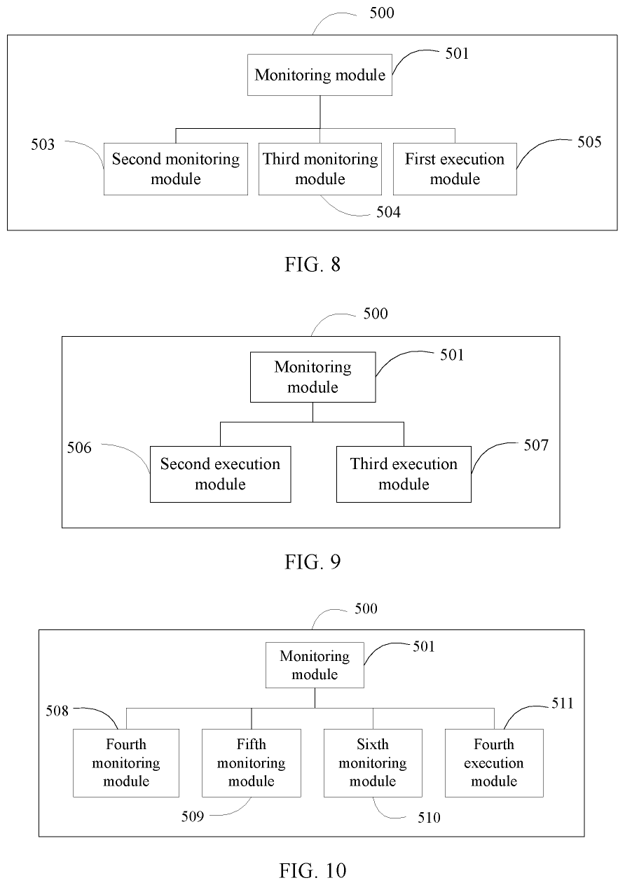

In some embodiments, as shown in FIG. 8, the terminal 500 further includes:

a second monitoring module 503, configured to: in a case that the first power-saving signal is detected, monitor the PDCCH in the onduration of the CDRX; or

a third monitoring module 504, configured to: in a case that power-saving signals detected in the at least one target power-saving signal MO are all the second power-saving signal, skip monitoring the PDCCH in the onduration of the CDRX; or

a first execution module 505, configured to: in a case that no power-saving signal is detected in the at least one target power-saving signal MO, perform a preset behavior.

In some embodiments, the monitoring module 501 is configured to monitor a power-saving signal in the first power-saving signal MO or the last power-saving signal MO of the at least one target power-saving signal MO.

In some embodiments, as shown in FIG. 9, the terminal 500 further includes:

a second execution module 506, configured to: in a case that a power-saving signal is detected, perform a monitoring action according to the detected power-saving signal, where the monitoring action includes monitoring the PDCCH in the onduration of the CDRX, or skip monitoring the PDCCH in the onduration of the CDRX; or

a third execution module 507, configured to: in a case that no power-saving signal is detected, perform a preset behavior.

In some embodiments, the monitoring module 501 monitors a power-saving signal in the at least one target power-saving signal MO.

In some embodiments, as shown in FIG. 10, the terminal 500 further includes:

a fourth monitoring module 508, configured to: in a case of detecting that the number of first power-saving signals indicating to monitor the PDCCH in the onduration of the CDRX is greater than or equal to N, monitor the PDCCH in the onduration of the CDRX, where N is an integer greater than or equal to 1; or

a fifth monitoring module 509, configured to: in a case of detecting that the number of second power-saving signals indicating not to monitor the PDCCH in the onduration of the CDRX is greater than or equal to X, skip monitoring the PDCCH in the onduration of the CDRX, where X is an integer greater than or equal to 1; or

a sixth monitoring module 510, configured to: in a case that power-saving signals detected in the at least one target power-saving signal MO are all the second power-saving signal, skip monitoring the PDCCH in the onduration of the CDRX; or

a fourth execution module 511, configured to: in a case that no power-saving signal is detected in the at least one target power-saving signal MO, perform a preset behavior.

In some embodiments, the first resource includes at least one of the following:

a resource for transmitting a first signal or a first channel;

a flexible symbol;

an uplink symbol;

an SMTC resource; and

a PDCCH candidate resource, where at least one resource element RE of the PDCCH candidate resource is a rate matching resource of radio resource control RRC configuration.

In some embodiments, the first signal or the first channel includes at least one of the following:

a synchronization signal block SSB, a channel state indication reference signal CSI-RS, a physical uplink control channel PUCCH, a physical uplink shared channel PUSCH, a sounding reference signal SRS, and a random access response RAR.

In some embodiments, the monitoring module 501 is configured to:

in a case that a third power-saving signal indicating not to start an onduration timer drx-ondurationtimer of a next DRX period is detected in the at least one target power-saving signal MO, skip monitoring a subsequent target power-saving signal MO;

or

in a case that a fourth power-saving signal indicating to start an onduration timer (drx-ondurationtimer) of a next DRX period is detected in the at least one target power-saving signal MO, continue to monitor a next target power-saving signal MO.

In some embodiments, the terminal further includes:

a fifth execution module, configured to: in a case that the third power-saving signal is detected, skip starting the onduration timer (drx-ondurationtimer) in the next DRX period.

In some embodiments, the monitoring module 501 is configured to: in a case that the fourth power-saving signal is detected, continue to monitor a next target power-saving signal MO until the third power-saving signal is detected or monitoring of the last target power-saving signal MO of the at least one target power-saving signal MO is completed.

In some embodiments, the terminal further includes:

a sixth execution module, configured to: in a case that power-saving signals detected in the at least one target power-saving signal MO are all the fourth power-saving signal, start the onduration timer (drx-ondurationtimer) in the next DRX period.

In some embodiments, the monitoring module 501 is configured to:

in a case that the third power-saving signal and the fourth power-saving signal in the at least one target power-saving signal MO are detected, perform a preset behavior, or stop monitoring and perform a preset behavior; where

the third power-saving signal indicates not to start an onduration timer drx-ondurationtimer of a next DRX period, and the fourth power-saving signal indicates to start an onduration timer drx-ondurationtimer of a next DRX period.

In some embodiments, the monitoring module 501 is configured to:

in a case that incorrect monitoring occurs in the at least one target power-saving signal MO, perform a preset behavior; or

in a case that incorrect monitoring occurs in the at least one target power-saving signal MO, skip monitoring a subsequent target power-saving signal MO and perform a preset behavior.

In some embodiments, the at least one target power-saving signal MO is: all power-saving signal MOs associated with the onduration of the CDRX;

or

the at least one target power-saving signal MO is: a power-saving signal MO other than an invalid power-saving signal MO among power-saving signal MOs associated with the onduration of the CDRX; where the invalid power-saving signal MO is a power-saving signal MO that overlaps with the first resource, and/or a power-saving signal MO in which the terminal does not need to perform monitoring.

In some embodiments, the terminal further includes:

a seventh execution module, configured to: in a case that power-saving signal MOs associated with the onduration of the CDRX include an invalid power-saving signal MO, skip monitoring other power-saving signal MOs, and perform a preset behavior.

In some embodiments, the terminal further includes:

a receiving module, configured to receive RRC signaling, where the RRC signaling carries first information for indicating the at least one target power-saving signal MO, and/or second information for indicating a monitoring action in the at least one target power-saving signal MO.

In some embodiments, the monitoring module 501 is configured to:

monitor a power-saving signal in the at least one target power-saving signal MO based on the RRC signaling.

The terminal provided in this embodiment of the present disclosure can implement the processes implemented by the terminal in the method embodiment in FIG. 2. To avoid repetition, details are not described herein again. Besides, the power-saving effect of the terminal can be improved.

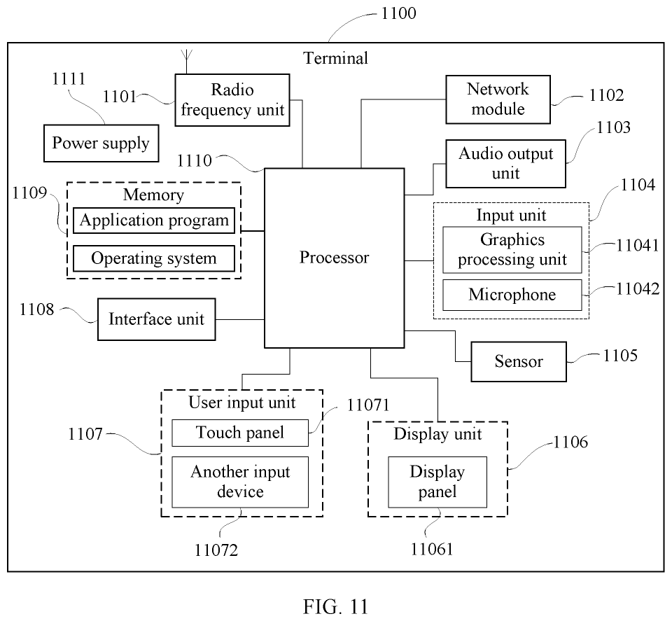

FIG. 11 is a schematic diagram of a hardware structure of a terminal implementing various embodiments of this disclosure.

The terminal 1100 includes but is not limited to: a radio frequency unit 1101, a network module 1102, an audio output unit 1103, an input unit 1104, a sensor 1105, a display unit 1106, a user input unit 1107, an interface unit 1108, a memory 1109, a processor 1110, a power supply 1111, and the like. A person skilled in the art may understand that the structure of the terminal shown in FIG. 11 does not constitute a limitation on the terminal, and the terminal may include more or fewer components than those shown in the figure, or combine some components, or have different component arrangements. In this embodiment of the present disclosure, the terminal includes but is not limited to a mobile phone, a tablet computer, a notebook computer, a palmtop computer, an in-vehicle terminal, a robot, a wearable device, a pedometer, and the like.

The radio frequency unit 1101 is configured to monitor a power-saving signal based on at least one target power-saving signal MO of power-saving signal MOs associated with onduration of connected discontinuous reception CDRX; where the power-saving signal MO is determined based on a power-saving signal offset and a search space parameter, the power-saving signal offset is an offset relative to the onduration of the CDRX, and the search space parameter includes at least one of the following: a monitoring period, a monitoring offset, and a monitoring duration.

In some embodiments, the step of monitoring a power-saving signal based on at least one target power-saving signal MO of power-saving signal MOs associated with onduration of CDRX includes:

selecting Z power-saving signal MOs that do not overlap with a first resource from the power-saving signal MOs associated with the onduration of the CDRX; where Z is an integer greater than or equal to 0; and

monitoring a power-saving signal based on at least one target power-saving signal MO of the Z power-saving signal MOs.

In some embodiments, the radio frequency unit 1101 is further configured to: monitor a physical downlink control channel PDCCH in the onduration of the CDRX in a case that Z is equal to 0.

In some embodiments, the step of monitoring a power-saving signal based on at least one target power-saving signal MO of the Z power-saving signal MOs includes:

monitoring a power-saving signal in the Z power-saving signal MOs in a case that Z is equal to 1;

or

selecting M target power-saving signal MOs from the Z power-saving signal MOs in a case that Z is greater than 1, and monitoring a power-saving signal based on the M target power-saving signal MOs; where the M target power-saving signal MOs are M power-saving signal MOs closest to the onduration of the CDRX or M power-saving signal MOs farthest from the onduration of the CDRX among the Z power-saving signal MOs; and M is an integer greater than 1 and less than Z.

In some embodiments, the step of monitoring a power-saving signal based on at least one target power-saving signal MO includes:

monitoring a power-saving signal from the first power-saving signal MO of the at least one target power-saving signal MO; and

in a case that a first power-saving signal indicating to monitor a physical downlink control channel PDCCH in the onduration of the CDRX is detected, skipping monitoring a subsequent target power-saving signal MO; or

in a case that the power-saving signal is not detected or a second power-saving signal indicating not to monitor the PDCCH in the onduration of the CDRX is detected, continuing to monitor a next target power-saving signal MO until the first power-saving signal is detected or monitoring of the last target power-saving signal MO of the at least one target power-saving signal MO is completed.

In some embodiments, the radio frequency unit 1101 is further configured to:

in a case that the first power-saving signal is detected, monitor the PDCCH in the onduration of the CDRX; or

in a case that power-saving signals detected in the at least one target power-saving signal MO are all the second power-saving signal, skip monitoring the PDCCH in the onduration of the CDRX; or

in a case that no power-saving signal is detected in the at least one target power-saving signal MO, perform a preset behavior.

In some embodiments, the step of monitoring a power-saving signal based on at least one target power-saving signal MO includes:

monitoring a power-saving signal in the first power-saving signal MO or the last power-saving signal MO of the at least one target power-saving signal MO.

In some embodiments, the radio frequency unit 1101 is further configured to:

in a case that a power-saving signal is detected, perform a monitoring action according to the detected power-saving signal, where the monitoring action includes monitoring the PDCCH in the onduration of the CDRX, or skip monitoring the PDCCH in the onduration of the CDRX; or

in a case that no power-saving signal is detected, perform a preset behavior.

In some embodiments, the step of monitoring a power-saving signal based on at least one target power-saving signal MO includes:

monitoring a power-saving signal in the at least one target power-saving signal MO.

In some embodiments, the radio frequency unit 1101 is further configured to:

in a case of detecting that the number of first power-saving signals indicating to monitor the PDCCH in the onduration of the CDRX is greater than or equal to N, monitor the PDCCH in the onduration of the CDRX, where N is an integer greater than or equal to 1; or

in a case of detecting that the number of second power-saving signals indicating not to monitor the PDCCH in the onduration of the CDRX is greater than or equal to X, skip monitoring the PDCCH in the onduration of the CDRX, where X is an integer greater than or equal to 1; or

in a case that power-saving signals detected in the at least one target power-saving signal MO are all the second power-saving signal, skip monitoring the PDCCH in the onduration of the CDRX; or

in a case that no power-saving signal is detected in the at least one target power-saving signal MO, perform a preset behavior.

In some embodiments, the first resource includes at least one of the following:

a resource for transmitting a first signal or a first channel;

a flexible symbol;

an uplink symbol;

an SMTC resource; and

a PDCCH candidate resource, where at least one resource element RE of the PDCCH candidate resource is a rate matching resource of radio resource control RRC configuration.

In some embodiments, the first signal or the first channel includes at least one of the following:

a synchronization signal block SSB, a channel state indication reference signal CSI-RS, a physical uplink control channel PUCCH, a physical uplink shared channel PUSCH, a sounding reference signal SRS, and a random access response RAR.

In some embodiments, the step of monitoring a power-saving signal based on at least one target power-saving signal MO includes:

in a case that a third power-saving signal indicating not to start an onduration timer (drx-ondurationtimer) of a next DRX period is detected in the at least one target power-saving signal MO, skipping monitoring a subsequent target power-saving signal MO;

or

in a case that a fourth power-saving signal indicating to start an onduration timer (drx-ondurationtimer) of a next DRX period is detected in the at least one target power-saving signal MO, continuing to monitor a next target power-saving signal MO.

In some embodiments, the terminal is further configured to:

in a case that the third power-saving signal is detected, skip starting the onduration timer (drx-ondurationtimer) in the next DRX period.

In some embodiments, the step of in a case that a fourth power-saving signal indicating to start an onduration timer (drx-ondurationtimer) of a next DRX period is detected in the at least one target power-saving signal MO, continuing to monitor a next target power-saving signal MO includes:

in a case that the fourth power-saving signal is detected, continuing to monitor a next target power-saving signal MO until the third power-saving signal is detected or monitoring of the last target power-saving signal MO of the at least one target power-saving signal MO is completed.

In some embodiments, the terminal is further configured to:

in a case that power-saving signals detected in the at least one target power-saving signal MO are all the fourth power-saving signal, start the onduration timer (drx-ondurationtimer) in the next DRX period.

In some embodiments, the step of monitoring a power-saving signal based on at least one target power-saving signal MO includes:

in a case that the third power-saving signal and the fourth power-saving signal in the at least one target power-saving signal MO are detected, performing a preset behavior, or stopping monitoring and perform a preset behavior; where

the third power-saving signal indicates not to start an onduration timer (drx-ondurationtimer) of a next DRX period, and the fourth power-saving signal indicates to start an onduration timer (drx-ondurationtimer) of a next DRX period.

In some embodiments, the step of monitoring a power-saving signal based on at least one target power-saving signal MO includes:

in a case that incorrect monitoring occurs in the at least one target power-saving signal MO, performing a preset behavior; or

in a case that incorrect monitoring occurs in the at least one target power-saving signal MO, skipping monitoring a subsequent target power-saving signal MO and perform a preset behavior.

In some embodiments, the at least one target power-saving signal MO is: all power-saving signal MOs associated with the onduration of the CDRX;

or

the at least one target power-saving signal MO is: a power-saving signal MO other than an invalid power-saving signal MO among power-saving signal MOs associated with the onduration of the CDRX; where the invalid power-saving signal MO is a power-saving signal MO that overlaps with the first resource, and/or a power-saving signal MO in which the terminal does not need to perform monitoring.

In some embodiments, the terminal is further configured to:

in a case that power-saving signal MOs associated with the onduration of the CDRX include an invalid power-saving signal MO, skip monitoring other power-saving signal MOs, and perform a preset behavior.

In some embodiments, before the step of monitoring a power-saving signal based on at least one target power-saving signal MO, the terminal is further configured to:

receive RRC signaling, where the RRC signaling carries first information for indicating the at least one target power-saving signal MO, and/or second information for indicating a monitoring action in the at least one target power-saving signal MO.

In some embodiments, the step of monitoring a power-saving signal based on at least one target power-saving signal MO includes:

monitoring a power-saving signal in the at least one target power-saving signal MO based on the RRC signaling.

The power-saving effect of the terminal can be improved.

It should be understood that in this embodiment of the present disclosure, the radio frequency unit 1101 may be configured to receive and send signals in a process of receiving and sending information or calling. Specifically, after receiving downlink data from a base station, the radio frequency unit sends the downlink data to the processor 1110 for processing; and sends uplink data to the base station. Generally, the radio frequency unit 1101 includes but is not limited to: an antenna, at least one amplifier, a transceiver, a coupler, a low noise amplifier, a duplexer, and the like. In addition, the radio frequency unit 1101 may further communicate with another device by using a wireless communication system and network.

The terminal provides wireless broadband Internet access for a user by using the network module 1102, for example, helps the user to send and receive an e-mail, browse a web page, and access streaming media.

The audio output unit 1103 may convert audio data received by the radio frequency unit 1101 or the network module 1102 or stored in the memory 1109 into an audio signal and output as voice. Moreover, the audio output unit 1103 may further provide audio output related to a specific function performed by the terminal 1100 (such as a call signal reception sound, a message reception sound, or the like). The audio output unit 1103 includes a speaker, a buzzer, a telephone receiver, and the like.

The input unit 1104 is configured to receive an acoustic signal or a video signal. The input unit 1104 may include a Graphics Processing Unit (GPU) 11041 and a microphone 11042. The graphics processing unit 11041 processes image data of a static image or video obtained by an image capture apparatus (such as, a camera) in a video capture mode or an image capture mode. A processed image frame may be displayed on the display unit 1106. The image frame processed by the graphics processing unit 11041 may be stored in the memory 1109 (or another storage medium) or sent through the radio frequency unit 1101 or the network module 1102. The microphone 11042 may receive sound and can process the sound into audio data. The processed audio data may be converted, in a call mode, into a format that may be sent to a mobile communication base station by using the radio frequency unit 1101 for output.

The terminal 1100 further includes at least one sensor 1105, such as a light sensor, a motion sensor, and other sensors. Specifically, the light sensor includes an ambient light sensor and a proximity sensor. The ambient light sensor may adjust luminance of the display panel 11061 based on brightness of ambient light. The proximity sensor may turn off the display panel 11061 and/or backlight when the terminal 1100 moves to an ear. As a type of motion sensor, an accelerometer sensor may detect an acceleration value in each direction (generally, three axes), and detect a value and a direction of gravity when the accelerometer sensor is static, and may be configured to recognize a terminal posture (such as switching between landscape and portrait modes, a related game, or magnetometer posture calibration), and perform a function related to vibration recognition (such as a pedometer or a knock), and the like. The sensor 1105 may further include a fingerprint sensor, a pressure sensor, an iris sensor, a molecular sensor, a gyroscope, a barometer, a hygrometer, a thermometer, an infrared sensor, and the like. Details are not described herein again.

The display unit 1106 is configured to display information entered by the user or information provided for the user. The display unit 1106 may include a display panel 11061, and the display panel 11061 may be configured in a form of Liquid Crystal Display (LCD), Organic Light-Emitting Diode (OLED), or the like.

A user input unit 1107 may be configured to receive input digital or character information, and generate key signal input related to user setting and function control of a terminal. Specifically, the user input unit 1107 includes a touch panel 11071 and other input devices 11072. The touch panel 11071, also called a touch screen, may collect touch operation on or near the touch panel by users (for example, operation on the touch panel 11071 or near the touch panel 11071 by fingers or any suitable objects or accessories such as a touch pen by the users). The touch panel 11071 may include two parts: a touch detection apparatus and a touch controller. The touch detection device detects a touch position of the user, detects a signal brought by the touch operation, and sends the signal to the touch controller. The touch controller receives touch information from the touch detection device, converts the touch information into touch point coordinates, sends the touch point coordinates to the processor 1110, and receives and executes a command sent by the processor 1110. In addition, the touch panel 11071 may be implemented by various types, such as a resistive type, a capacitive type, an infrared type, a surface acoustic wave type, or the like. The user input unit 1107 may further include other input devices 11072 in addition to the touch panel 11071. Specifically, the other input devices 11072 may include, but is not limited to, a physical keyboard, function keys (such as a volume control key and a switch key), a trackball, a mouse, and a joystick. Details are not described herein.

Further, the touch panel 11071 may cover the display panel 11061. After detecting the touch operation on or near the touch panel 11071, the touch panel 11071 transmits the touch operation to the processor 1110 to determine a type of a touch event, and then the processor 1110 provides corresponding visual output on the display panel 11061 based on the type of the touch event. Although in FIG. 11, the touch panel 11071 and the display panel 11061 implement input and output functions of the terminal as two independent components, in some embodiments, the touch panel 11071 and the display panel 11061 may be integrated to implement the input and output functions of the terminal. This is not specifically limited herein.

The interface unit 1108 is an interface for connecting an external apparatus to the terminal 1100. For example, the external apparatus may include a wired or wireless headset port, an external power supply (or battery charger) port, a wired or wireless data port, a storage card port, a port configured to connect to an apparatus having a recognition module, an audio input/output (I/O) port, a video I/O port, a headset port, and the like. The interface unit 1108 may be configured to receive an input (such as data information or electric power) from the external apparatus and transmit the received input to one or more elements of the terminal 1100, or may be configured to transmit data between the terminal 1100 and the external apparatus.

The memory 1109 may be configured to store a software program and various data. The memory 1109 may mainly include a program storage area and a data storage area. The program storage area may store an operating system, an application required by at least one function (for example, a sound play function or an image display function), and the like. The data storage area may store data (for example, audio data or an address book) or the like created based on use of the mobile phone. In addition, the memory 1109 may include a high-speed random access memory or a nonvolatile memory, for example, at least one disk storage device, a flash memory, or other volatile solid-state storage devices.

The processor 1110 is a control center of the terminal, and connects all parts of the entire terminal through various interfaces and lines. By running or executing a software program and/or a module stored in the memory 1109 and invoking data stored in the memory 1109, the processor performs various functions of the terminal and data processing, to perform overall monitoring on the terminal. The processor 1110 may include one or more processing units. The processor 1110 may be integrated with an application processor and a modem processor. The application processor mainly processes the operating system, the user interface, applications, etc. The modem processor mainly processes wireless communication. It may be understood that the modem processor may not be integrated into the processor 1110.

The terminal 1100 may further include a power supply 1111 (for example, a battery) that supplies power to various components. The power supply 1111 may be logically connected to the processor 1110 through a power supply management system, thereby achieving functions of managing charging, discharging, and power consumption through the power supply management system.

In addition, the terminal 1100 includes some function modules that are not shown, and details are not provided herein.

In some embodiments, an embodiment of the present disclosure further provides a terminal, including a processor 1110, a memory 1109, and a computer program stored in the memory 1109 and executable on the processor 1110. When the computer program is executed by the processor 1110, each process of the foregoing embodiments of the power-saving signal monitoring method can be implemented, and a same technical effect can be achieved. To avoid repetition, details are not described herein again.

An embodiment of the present disclosure further provides a computer-readable storage medium. A computer program is stored in the computer-readable storage medium. When the computer program is executed by a processor, the foregoing power-saving signal monitoring method provided in the embodiments of this application can be implemented, and a same technical effect can be achieved. To avoid repetition, details are not described herein. The computer-readable storage medium includes a Read-Only Memory (ROM), a Random Access Memory (RAM), a magnetic disk, an optical disc, or the like.

It should be noted that in this specification, the terms “include”, “include”, and any other variants thereof are intended to cover non-exclusive inclusion, so that a process, a method, an article, or an apparatus that includes a series of elements not only includes these very elements, but also includes other elements not expressly listed, or also includes elements inherent to this process, method, article, or apparatus. In the absence of more restrictions, an element defined by the statement “including a . . . ” does not exclude presence of another same element in a process, method, article, or apparatus that includes the element.

By means of the foregoing description of the implementations, a person skilled in the art may clearly understand that the method in the foregoing embodiments may be implemented by software with a necessary general hardware platform. Certainly, the method in the foregoing embodiments may also be implemented by hardware. However, in many cases, the former is an exemplary implementation. Based on such an understanding, the technical solutions of the present disclosure essentially or the part contributing to the related technologies may be implemented in a form of a software product. The computer software product is stored in a storage medium (for example, a ROM/RAM, a magnetic disk, or a compact disc), and includes a plurality of indications for indicating a terminal (which may be a mobile phone, a computer, a server, an air conditioner, a network device, or the like) to perform the method described in the embodiments of the present disclosure.

The embodiments of the present disclosure are described above with reference to the accompanying drawings, but the present disclosure is not limited to the foregoing specific implementations. The foregoing specific implementations are merely schematic instead of restrictive. Under enlightenment of the present disclosure, a person of ordinary skills in the art may make many forms without departing from the aims of the present disclosure and the protection scope of claims, all of which fall within the protection of the present disclosure.

1. A power-saving signal monitoring method, executed by a terminal, comprising:
monitoring a power-saving signal based on at least one target power-saving signal Monitoring Occasion (MO) of power-saving signal MOs associated with onduration of Connected Discontinuous Reception (CDRX), wherein the power-saving signal MOs are determined based on a power-saving signal offset and a search space parameter, wherein the power-saving signal offset is an offset relative to the onduration of the CDRX, and the search space parameter comprises at least one of the following: a monitoring period, a monitoring offset, or a monitoring duration.

2. The power-saving signal monitoring method according to claim 1, wherein the terminal does not expect to receive different indications from the power-saving signal for one onduration of CDRX in the at least one target power-saving signal MO.

3. The power-saving signal monitoring method according to claim 1, wherein:
monitoring the power-saving signal based on the at least one target power-saving signal MO of the power-saving signal MOs associated with the onduration of the CDRX comprises:
selecting Z power-saving signal MOs that do not overlap with a first resource from the power-saving signal MOs associated with the onduration of the CDRX, wherein Z is an integer greater than or equal to 0; and
monitoring a power-saving signal based on at least one target power-saving signal MO of the Z power-saving signal MOs;
or
the power-saving signal monitoring method further comprises:
monitoring a Physical Downlink Control CHannel (PDCCH) in the onduration of the CDRX in a case that Z is equal to 0.

4. The power-saving signal monitoring method according to claim 3, wherein monitoring the power-saving signal based on the at least one target power-saving signal MO of the Z power-saving signal MOs comprises:
monitoring a power-saving signal in the Z power-saving signal MOs in a case that Z is equal to 1;
or
selecting M target power-saving signal MOs from the Z power-saving signal MOs in a case that Z is greater than 1, and monitoring a power-saving signal based on the M target power-saving signal MOs, wherein the M target power-saving signal MOs are M power-saving signal MOs closest to the onduration of the CDRX or M power-saving signal MOs farthest from the onduration of the CDRX among the Z power-saving signal MOs, and M is an integer greater than 1 and less than or equal to Z.

5. The power-saving signal monitoring method according to claim 1, wherein monitoring the power-saving signal based on the at least one target power-saving signal MO comprises:
monitoring a power-saving signal from a first one power-saving signal MO of the at least one target power-saving signal MO; and
in a case that a first power-saving signal indicating to monitor a PDCCH in the onduration of the CDRX is detected, skipping monitoring a subsequent target power-saving signal MO; or
in a case that a power-saving signal is not detected or a second power-saving signal indicating not to monitor the PDCCH in the onduration of the CDRX is detected, continuing to monitor a next target power-saving signal MO until the first power-saving signal is detected or monitoring of the last target power-saving signal MO of the at least one target power-saving signal MO is completed.

6. The power-saving signal monitoring method according to claim 5, further comprising:
in a case that the first power-saving signal is detected, monitoring the PDCCH in the onduration of the CDRX;
in a case that power-saving signals detected in the at least one target power-saving signal MO are all the second power-saving signal, skipping monitoring the PDCCH in the onduration of the CDRX; or
in a case that no power-saving signal is detected on the at least one target power-saving signal MO, performing a preset behavior.

7. The power-saving signal monitoring method according to claim 1, wherein monitoring the power-saving signal based on the at least one target power-saving signal MO comprises one of following:
monitoring a power-saving signal on a first one power-saving signal MO or a last one power-saving signal MO of the at least one target power-saving signal MO; or
monitoring a power-saving signal on the at least one target power-saving signal MO.

8. The power-saving signal monitoring method according to claim 7, further comprising:
in a case that a power-saving signal is detected, performing a monitoring action according to a detected power-saving signal, wherein the monitoring action comprises monitoring the PDCCH in the onduration of the CDRX, or skipping monitoring the PDCCH in the onduration of the CDRX; or
in a case that no power-saving signal is detected, performing a preset behavior.

9. The power-saving signal monitoring method according to claim 7, further comprising:
in a case of detecting that the number of first power-saving signals indicating to monitor the PDCCH in the onduration of the CDRX is greater than or equal to N, monitoring the PDCCH in the onduration of the CDRX, wherein N is an integer greater than or equal to 1;
in a case of detecting that the number of second power-saving signals indicating not to monitor the PDCCH in the onduration of the CDRX is greater than or equal to X, skipping monitoring the PDCCH in the onduration of the CDRX, wherein X is an integer greater than or equal to 1;
in a case that power-saving signals detected on the at least one target power-saving signal MO are all the second power-saving signal, skipping monitoring the PDCCH in the onduration of the CDRX; or
in a case that no power-saving signal is detected on the at least one target power-saving signal MO, performing a preset behavior.

10. The power-saving signal monitoring method according to claim 1, wherein monitoring the power-saving signal based on the at least one target power-saving signal MO comprises:
in a case that a third power-saving signal indicating not to start drx-ondurationtimer of a next DRX period is detected in the at least one target power-saving signal MO, skipping monitoring a subsequent target power-saving signal MO;
in a case that a fourth power-saving signal indicating to start drx-ondurationtimer of a next DRX period is detected in the at least one target power-saving signal MO, continuing to monitor a next target power saving signal MO;
or
in a case that the third power-saving signal and the fourth power-saving signal in the at least one target power-saving signal MO are detected, performing a preset behavior, or stopping monitoring and performing a preset behavior.

11. The power-saving signal monitoring method according to claim 1, wherein monitoring the power-saving signal based on the at least one target power-saving signal MO comprises:
in a case that incorrect monitoring occurs on all of the at least one target power-saving signal MO, performing a preset behavior; or
in a case that incorrect monitoring occurs on the at least one target power-saving signal MO, skipping monitoring a subsequent target power-saving signal MO and performing a preset behavior.

12. The power-saving signal monitoring method according to claim 1, before monitoring the power-saving signal based on the at least one target power-saving signal MO, further comprising:
receiving Radio Resource Control (RRC) signaling, wherein the RRC signaling carries first information for indicating the at least one target power-saving signal MO, or second information for indicating a monitoring action on the at least one target power-saving signal MO.

13. A terminal, comprising: a memory, a processor, and a computer program stored in the memory and executable on the processor, wherein the computer program, when executed by the processor, causes the processor to implement operations comprising:
monitoring a power-saving signal based on at least one target power-saving signal Monitoring Occasion (MO) of power-saving signal MOs associated with onduration of Connected Discontinuous Reception (CDRX), wherein the power-saving signal MOs are determined based on a power-saving signal offset and a search space parameter, wherein the power-saving signal offset is an offset relative to the onduration of the CDRX, and the search space parameter comprises at least one of the following: a monitoring period, a monitoring offset, or a monitoring duration.

14. The terminal according to claim 13, wherein the terminal does not expect to receive different indications from the power-saving signal for one onduration of CDRX in the at least one target power-saving signal MO.

15. The terminal according to claim 13, wherein:
monitoring the power-saving signal based on the at least one target power-saving signal MO of the power-saving signal MOs associated with the onduration of the CDRX comprises:
selecting Z power-saving signal MOs that do not overlap with a first resource from the power-saving signal MOs associated with the onduration of the CDRX, wherein Z is an integer greater than or equal to 0; and
monitoring a power-saving signal based on at least one target power-saving signal MO of the Z power-saving signal MOs;
or
the operations further comprise:
monitoring a Physical Downlink Control CHannel (PDCCH) in the onduration of the CDRX in a case that Z is equal to 0.

16. The terminal according to claim 15, wherein monitoring the power-saving signal based on the at least one target power-saving signal MO of the Z power-saving signal MOs comprises:
monitoring a power-saving signal in the Z power-saving signal MOs in a case that Z is equal to 1;
or
selecting M target power-saving signal MOs from the Z power-saving signal MOs in a case that Z is greater than 1, and monitoring a power-saving signal based on the M target power-saving signal MOs, wherein the M target power-saving signal MOs are M power-saving signal MOs closest to the onduration of the CDRX or M power-saving signal MOs farthest from the onduration of the CDRX among the Z power-saving signal MOs, and M is an integer greater than 1 and less than or equal to Z.

17. The terminal according to claim 13, wherein monitoring the power-saving signal based on the at least one target power-saving signal MO comprises:
monitoring a power-saving signal from a first one power-saving signal MO of the at least one target power-saving signal MO; and
one of the following:
in a case that a first power-saving signal indicating to monitor a PDCCH in the onduration of the CDRX is detected, skipping monitoring a subsequent target power-saving signal MO; or
in a case that a power-saving signal is not detected or a second power-saving signal indicating not to monitor the PDCCH in the onduration of the CDRX is detected, continuing to monitor a next target power-saving signal MO until the first power-saving signal is detected or monitoring of the last target power-saving signal MO of the at least one target power-saving signal MO is completed.

18. The terminal according to claim 17, wherein the operations further comprise:
in a case that the first power-saving signal is detected, monitoring the PDCCH in the onduration of the CDRX;
in a case that power-saving signals detected in the at least one target power-saving signal MO are all the second power-saving signal, skipping monitoring the PDCCH in the onduration of the CDRX; or
in a case that no power-saving signal is detected on the at least one target power-saving signal MO, performing a preset behavior.

19. The terminal according to claim 13, wherein monitoring the power-saving signal based on the at least one target power-saving signal MO comprises one of the following:
monitoring a power-saving signal on a first one power-saving signal MO or a last one power-saving signal MO of the at least one target power-saving signal MO; or
monitoring a power-saving signal on the at least one target power-saving signal MO.

20. A non-transitory computer readable storage medium, wherein the non-transitory computer readable storage medium stores a computer program, and the computer program, when executed by a processor, causes the processor to implement operations comprising:
monitoring a power-saving signal based on at least one target power-saving signal Monitoring Occasion (MO) of power-saving signal MOs associated with onduration of Connected Discontinuous Reception (CDRX), wherein the power-saving signal MO are determined based on a power-saving signal offset and a search space parameter, wherein the power-saving signal offset is an offset relative to the onduration of the CDRX, and the search space parameter comprises at least one of the following: a monitoring period, a monitoring offset, or a monitoring duration.
